(19) United States
(12) Patent Application Publication
(10) Pub. No.: US 2024/0023211 A1
(43) Pub. Date: Jan. 18, 2024

(54) RF POWER MODULE WITH A CONNECTORLESS RF RADIATING ELEMENT

(71) Applicant: Joliet 2010 Limited, Tortola (VG)

(72) Inventors: Reuven MELAVER, Tel Aviv (IL); Shalom Mordehay KADOSH, Kiryat Malachi (IL); Ronen COHEN, Pardesiya (IL); Lior DARSHAN, Rishon LeZion (IL)

(73) Assignee: Joliet 2010 Limited, Tortola (VG)

(21) Appl. No.: 18/245,263

(22) PCT Filed: Aug. 22, 2021
(86) PCT No.: PCT/IL2021/051025

§ 371 Date: Mar. 14, 2023

Related U.S. Application Data
(60) Provisional application No. 63/078,366, filed on Sep. 15, 2020.

(51) Int. Cl. H05B 6/66; H05B 6/72; H05B 6/70; H05B 6/76

(52) U.S. Cl. CPC H05B 6/664; H05B 6/72; H05B 6/707; H05B 6/76; H05B 2206/044

(57) ABSTRACT

Disclosed are RF power modules, and RF ovens, each having one or more RF power modules. In particular, a disclosed RF power module may include a printed circuit board (PCB) having a trace; and a radiating element having a first end portion and a second end portion. The first end portion is in electrical communication with the trace of the of PCB, and the second end portion in operable communication with a microwave cavity, and the radiating element is disposed and soldered in parallel to the trace.

### FIELD OF THE INVENTION

The present invention is in the field of radiofrequency (RF) technology, in feeding cavities and/or waveguides with waves generated using solid state devices.

### BACKGROUND OF THE INVENTION

Electromagnetic waves are commonly used to transfer energy to objects, such as objects located in a hollow structure configured to receive electromagnetic energy. In a microwave oven, microwaves are used to apply electromagnetic energy from an energy source to the food to be heated. The electromagnetic energy is then absorbed by the food, in particular by water molecules that vibrate to produce thermal energy, causing the temperature of the food to rise.

Usually, the source of the electromagnetic waves in a microwave oven is a magnetron, which is an inexpensive component, but does not allow controlling its frequency and output power.

It is believed that the following publications represent the relevant technology in the field: U.S. Pat. No. 10,575,373; US2012/152937; US2012/152938; CN102769952A; CN205332285U; CN102767855B; and CN105485732A. The teachings of the aforementioned publications are incorporated by reference as if fully set forth herein.

### SUMMARY OF THE INVENTION

Some exemplary aspects of the invention may be directed to a radiofrequency (RF) power module comprising: a printed circuit board (PCB) having a trace; and a radiating element having a first end portion and a second end portion. The first end portion of the radiating element is in electrical communication with the trace of the PCB, and the second end portion of the radiating element is in operable communication with a microwave cavity. The radiating element is disposed and soldered in parallel to the trace.

In some embodiments, the cavity is configured to hold an object to be heated.

In some embodiments, the power module further comprises a clamping member configured to clamp a waveguide to the PCB so that the radiating element is in contact with the trace.

In some embodiments, the power module further comprises a waveguide wherein the second end of the radiating element is disposed within the waveguide. Optionally, the second end portion of the radiating element is disposed within the waveguide without any connection fitting.

In some embodiments, the waveguide is connected to the PCB via a connection between an attachment plate and a bracket.

In some embodiments, the power module further comprises an RF sealing arrangement configured to prevent RF leakage from between the waveguide (52) and the PCB (22).

Some exemplary aspects of the invention may be directed to an RF oven comprising: two RF power modules, each configured as described above; a cavity, configured to process an object with RF power originating in the two RF power modules; and two waveguides, each configured to guide waves from a respective one of the RF power modules to the cavity. The radiating elements differ from one another so as to maximize the efficiency of RF power transfer from each of the RF power modules to the cavity. The cavity may be a resonator cavity or a Faraday cavity (Faraday cage).

In some embodiments, each of the radiating elements has a first end attached to the respective RF power module and a second end inside the respective waveguide, and wherein the first end is the same in the two RF power modules, and the second ends differ between the two RF power modules. Optionally, the second ends differ in length by at least 0.5 mm. Additionally or alternatively, the second ends differ in width by at least 10%. Additionally or alternatively, the second ends differ in shape.

In some embodiments, exchanging between the two power modules, without changing the RF cavity, waveguides, or radiating structures, does not change the efficiency of RF power transfer from the RF power modules to the cavity by more than 1%.

Some exemplary aspects of the invention may be directed to two RF ovens, each comprising: an RF power module as described above; and an RF consumer configured to process an object with RF power, wherein the radiating element of each RF power module is arranged in a radiating structure configured to match the output impedance of the respective RF power module to input impedance of the respective RF consumer, and the RF consumers differ from one another in input impedance by at least 10%.

In some embodiments, each RF consumer comprises a cavity configured to: receive an object to be processed by RF power, and receive RF power originating in the RF power module. Optionally, one or more of the RF consumers further comprises a waveguide configured to guide waves from the RF power module to the cavity.

In some embodiments, one or more of the cavities is a resonator cavity. Optionally, one or more of the cavities is a Faraday cavity.

In some embodiments, the radiating element of each oven has a first end attached to the respective RF power module and a second end inside the respective RF consumer. The first end is the same in the two RF ovens, and the second ends differ between the two RF ovens. Optionally, the second ends differ in length and/or width by at least 5%. Alternatively or additionally, the second ends differ in shape.

In some embodiments, replacing the power module of a first one of the two RF ovens with the power module of a second one of the two RF ovens, without changing the RF consumer and without changing the radiating structure of the first RF oven, does not change the efficiency of the RF oven by more than 1%.

Some exemplary aspects of the invention may be directed to two RF ovens, each comprising a universal RF power module having output impedance; an RF consumer configured to process an object with RF power; and a radiating element arranged in a radiating structure configured to match the output impedance of the universal RF power module to input impedance of the respective RF consumer. The RF consumers differ from one another in input impedance by at least 10%.

In some embodiments, the universal power module comprises a solid state amplifier mounted on a PCB; and a trace printed on the PCB and configured to connect the amplifier to the radiating element.

In some embodiments, each RF consumer comprises a cavity configured to receive an object to be processed by RF power, and receive RF power originating in the universal RF power module. Optionally, one or more of the RF consumers further comprises a waveguide configured to guide waves from the universal RF power module to the cavity.

In some embodiments, each radiating structure comprises a clamping member configured to clamp a respective waveguide to the PCB so that the radiating element is in contact with the trace.

In some embodiments, the radiating element is soldered to the trace. Additionally or alternatively, the radiating element is oriented in parallel to the PCB.

In some embodiments, one or more of the cavities is a resonator cavity. Additionally or alternatively, one or more of the cavities is a Faraday cavity.

In some embodiments, the radiating element of each oven has a first end attached to the respective RF power module and a second end inside the respective RF consumer, and wherein the first end is the same in the two RF ovens, and the second ends differ between the two RF ovens. Optionally, the second ends differ in length by at least 5%. Additionally or alternatively, the second ends differ in width by at least 5%. Additionally or alternatively, the second ends differ in shape.

In some embodiments, replacing the power module of a first one of the two RF ovens with the power module of a second one of the two RF ovens, without changing the RF consumer and without changing the radiating structure of the first RF oven, does not change the efficiency of the RF oven by more than 1%.

Some exemplary aspects of the invention may be directed to an RF oven comprising two functionally identical RF power modules, each having the same output impedance; a cavity, configured to process an object with RF power originating in the two functionally identical RF power modules; two waveguides, each configured to guide waves from a respective one of the identical RF power modules to the cavity; and two radiating elements, each arranged in a respective radiating structure configured to match the output impedance of the respective RF power module to input impedance of the respective waveguide. The radiating elements differ from one another so as to maximize the efficiency of RF power transfer from each of the RF power modules to the cavity.

In some embodiments, each of the functionally identical power modules comprises: a PCB; a solid state amplifier mounted on the PCB; and a trace printed on the PCB and configured to connect the amplifier to the radiating element.

In some embodiments, each radiating structure comprises a clamping member configured to clamp the waveguide to the PCB so that the radiating element is in contact with the trace.

In some embodiments, each radiating element is soldered to a respective trace on the respective PCB. Additionally or alternatively, each radiating element is oriented in parallel to the respective PCB.

In some embodiments, the cavity is a resonator cavity. Alternatively, the cavity is a Faraday cavity.

In some embodiments, each of the radiating elements has a first end attached to the respective RF power module and a second end inside the respective waveguide, and wherein the first end is the same in the two RF power modules, and the second ends differ between the two RF power modules. Optionally, the second ends differ in length by at least 5%. Alternatively or additionally, the second ends differ in width by at least 5%. Alternatively or additionally, the second ends differ in shape.

In some embodiments, exchanging between the two functionally identical power modules, without changing the RF cavity, waveguides, or radiating structures, does not change the efficiency of RF power transfer from the functionally identical RF power modules to the cavity by more than 1%.

Unless otherwise defined, all technical and/or scientific terms used herein have the same meaning as commonly understood by one of ordinary skill in the art to which the present disclosure pertains. Although methods and materials similar or equivalent to those described herein can be used in the practice or testing of embodiments of the present disclosure, exemplary methods and/or materials are described below. In case of conflict, the patent specification, including definitions, will control. In addition, the materials, methods, and examples are illustrative only and are not intended to be necessarily limiting.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system” (e.g., a method may be implemented using “computer circuitry”). Furthermore, some embodiments of the present disclosure may take the form of a computer program product embodied in one or more computer readable medium(s) having computer readable program code embodied thereon. Implementation of the method and/or system of some embodiments of the present disclosure can involve performing and/or completing selected tasks manually, automatically, or a combination thereof. Moreover, according to actual instrumentation and equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computer using any suitable operating system. In some embodiments of the present disclosure, one or more tasks performed in method and/or by system are performed by a data processor (also referred to herein as a “digital processor”, in reference to data processors which operate using groups of digital bits), such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well. Any of these implementations are referred to herein more generally as instances of computer circuitry.

Any combination of one or more computer readable medium(s) may be utilized for some embodiments of the present disclosure. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable storage medium may also contain or store information for use by such a program, for example, data structured in the way it is recorded by the computer readable storage medium so that a computer program can access it as, for example, one or more tables, lists, arrays, data trees, and/or another data structure. Herein a computer readable storage medium which records data in a form retrievable as groups of digital bits is also referred to as a digital memory. It should be understood that a computer readable storage medium, in some embodiments, is optionally also used as a computer writable storage medium, in the case of a computer readable storage medium which is not read-only in nature, and/or in a read-only state.

Herein, a data processor is said to be “configured” to perform data processing actions insofar as it is coupled to a computer readable memory to receive instructions and/or data therefrom, process them, and/or store processing results in the same or another computer readable storage memory. The processing performed (optionally on the data) is specified by the instructions. The act of processing may be referred to additionally or alternatively by one or more other terms; for example: comparing, estimating, determining, calculating, identifying, associating, storing, analyzing, selecting, and/or transforming. For example, in some embodiments, a digital processor receives instructions and data from a digital memory, processes the data according to the instructions, and/or stores processing results in the digital memory. In some embodiments, “providing” processing results comprises one or more of transmitting, storing and/or presenting processing results. Presenting optionally comprises showing on a display, indicating by sound, printing on a printout, or otherwise giving results in a form accessible to human sensory capabilities.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present disclosure may be described below with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### BRIEF DESCRIPTION OF THE DRAWINGS

The invention may be more clearly understood upon reading of the following detailed description of non-limiting exemplary embodiments thereof, with reference to the following drawings, in which:

FIG. 1 is a schematic representation of a solid state radiofrequency (RF) power module in accordance with an exemplary embodiment;

FIG. 2 is a an enlarged view of an RF radiating element within a clamping member, according to some embodiments;

FIG. 3A is a schematic representation of a radiating element soldered to a PCB according to some embodiments;

FIGS. 3B, 3C, and 3D are schematic illustrations of various RF ovens according to different embodiments;

FIG. 4 is a perspective view of an exemplary solid-state RF power module illustrating an exemplary bracket for connecting the waveguide to the module; and

FIG. 5 is a perspective view of an exemplary waveguide designed to connect to an RF power module according to embodiments.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF EMBODIMENTS

The present invention relates to a structure for establishing an RF connection. The structure is particularly suited for connecting between a solid-state RF power module and a waveguide, but can be used for other implementations, mutatis mutandis, and in particular for connecting between a solid state RF power module and a cavity. The cavity may be a resonator cavity (in which the waves resonate to form field patterns filling a substantial portion of the cavity) or a Faraday cavity. The Faraday cavity may be configured to prevent RF leakage from the cavity (e.g., for safety), and the object to be heated may arranged to absorb evanescent waves.

The terms “radiofrequency” and “RF” and their derivatives should be understood to include the microwave frequencies, in the range of about 300 MHz to around 30 GHz. In particular, RF includes ISM frequency bands, including 902-928 MHz and 2400 to 2500 MHz.

An aspect of some embodiments of the technology includes a solid state RF power module. In some embodiments, the power module is configured to be incorporated in an oven that has RF heating capabilities, so as to supply to the oven RF power to process objects, e.g., to cook food. The object is to be processed in a resonator cavity, in which one or more of the RF waves used for the processing resonates. The power module is in operable communication with the cavity in the sense that the module is configured to feed the cavity with RF waves, either directly, or via a waveguide.

The RF module is referred to herein as a solid state RF module, as it includes at least an RF signal source and/or an amplifier based on semiconductor technology. Such devices do not include moving parts, so they are also referred to as solid state devices. The solid state amplifier may include a transistor. The solid state signal source may include, for example, a voltage controlled oscillator (VCO) or a direct digital synthesizer (DDS).

The afore-mentioned solid state devices are mounted on a printed circuit board. In some embodiments, a radiating element (which may be, for example, an RF antenna, a pin, or any other radiating element) is also mounted on the PCB. In some embodiments, the radiating element is mounted to the PCB by soldering, optionally by a surface mount technology (SMT). The radiating element may be soldered to a trace on the PCB, and the trace may lead RF signals to the radiating element, for example, from a solid state amplifier, optionally, via other solid state devices, such as a coupler (e.g., a dual directional coupler), a circulator, etc. In some embodiments, the trace may be a portion of a transmission line, e.g. a strip line or a microstrip.

In some embodiments, the radiating element has two end portions, one electrically connected to an RF signal source, and the other to a cavity. The connection to the signal source may be via one or more solid state devices, such as an amplifier, dual directional coupler, oscillator, etc., and the connection to the cavity may be via a waveguide. Thus, in some embodiments, the radiating element has one end portion disposed within a waveguide, and in some embodiments, within a resonator cavity. The cavity or waveguide may be connected to the PCB by a bracket, e.g., by fasteners such as screws. Optionally, a gasket or other RF sealing arrangement is arranged between the waveguide (or cavity) and the PCB, so as to prevent RF leakage to the environment, or at least reduce the leakage to power levels allowable by the regulatory authorities.

In some embodiments, the RF radiating element is disposed parallel to the PCB, in a manner that obviates the need for any connecting fittings, sockets, or any other structure configured to connect between a trace on the PCB and the radiating element. In some embodiments, the radiating element is connected to a trace on the PCB by soldering, optionally, only by soldering. Optionally, the radiating element may be further supported, e.g., by an appropriate clamping member, but the electrical connection of the radiating element to the PCB is preferably direct, e.g., by soldering to a trace on the PCB.***

An aspect of some embodiments of the invention is a method of making an RF power module as described above. The method may include soldering the radiating element to the PCB, optionally by surface mount technology. The method may also include, before the soldering, assembling the radiating element to an attachment clamping member; and fastening the clamping member to the PCB.

In some embodiments, the method further includes attaching the PCB to a waveguide after the radiating element is soldered to the trace, so that the second end portion of the RF radiating element (i.e., the end portion not soldered to the trace) extends into the waveguide. The method may also include fastening the waveguide to the PCB.

Illustrative embodiments of the invention are described below. In the interest of clarity, not all features/components of an actual implementation are necessarily described.

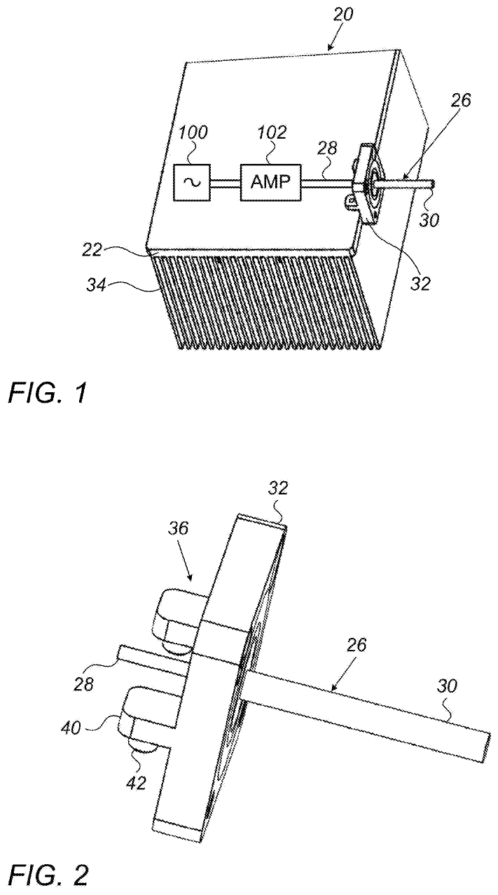

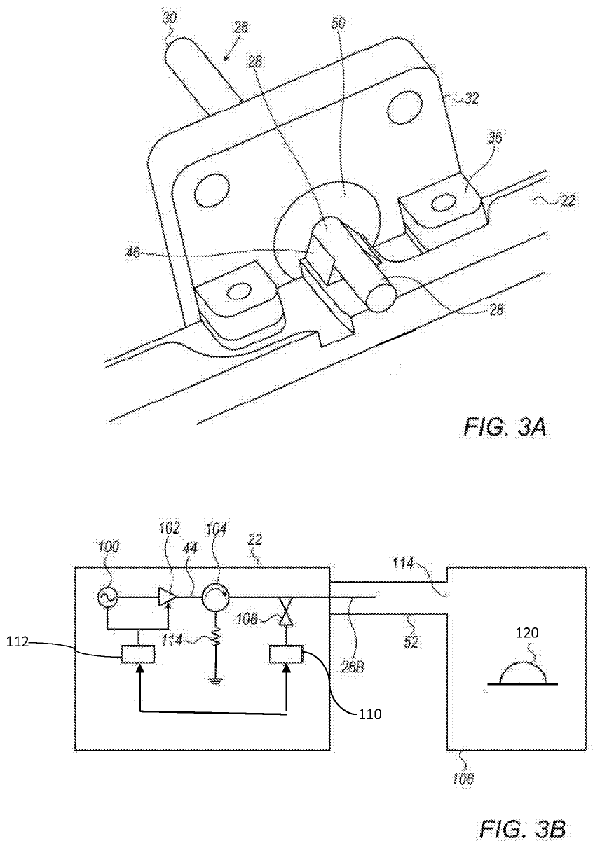

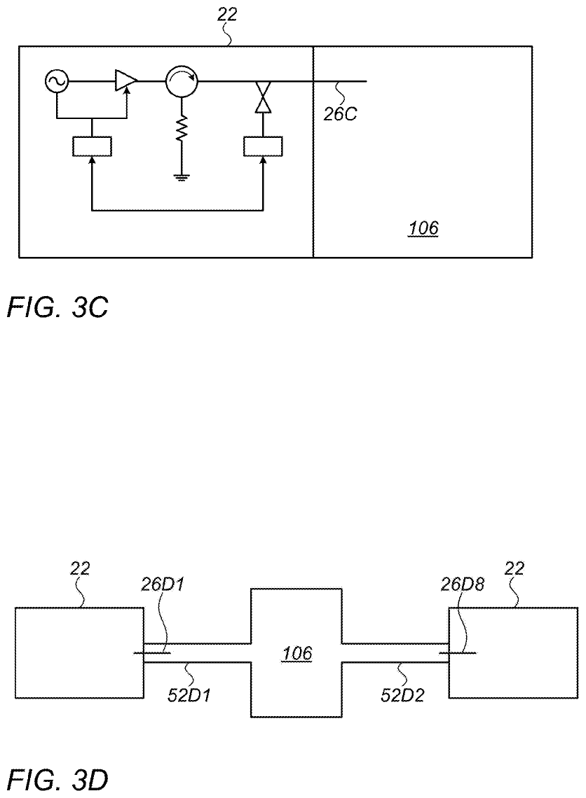

FIG. 1 shows a solid state radiofrequency (RF) power module in accordance with an embodiment of the present technology. The RF power module includes a PCB (22) comprising a non-conducting substrate with electrical circuit printed thereon. The electrical circuit is illustrated in FIG. 1 as connecting a signal source 100, to amplifier 102, and from there to a radiating element 26. The signal source may be, for example, a voltage controlled oscillator (VCO), a direct digital synthesizer (DDS), or any other frequency agile solid state signal source. The signal source 100 and amplifier 102 may be mounted on the PCB, for example, by surface mount technology. In practice, there may be additional devices mounted on the PCB, as illustrated, for example, in FIG. 3B. The power module also includes the RF radiating element 26 (e.g. an antenna, a pin or the like) having a first end portion 28 and a second end portion 30. The radiating element's second end portion 30 is in operable communication with a microwave cavity (e.g., 106), which is configured to hold an object to be heated, such as food. A radiating element is in operable commumication with a microwave cavity when most of the radiation from the radiating element (e.g., more than 50%, 90%, 99%, or the like) enters the microwave cavity. The radiating element 26 may be in operable communication with the cavity via a waveguide (e.g., 52). The RF power module may further include a clamping member 32 configured to support RF radiating element 26 and aid in attaching the radiating element to PCB 22, during and after assembly/manufacture. The RF power module typically also includes a heat sink that includes fins 34.

FIG. 2 shows an enlarged view of RF radiating element 26 with its clamping member 32. Clamping member 32 may have an alignment connector 36. Alignment connector 36 is illustrated by a pair of connector prongs 40 each having a PCB connection boss 42 on the bottom side thereof. Connection bosses 42 are disposed to align with corresponding boss receiving recesses in PCB 22.

FIG. 3A shows PCB 22 with a trace 44 that extends from an amplifier (e.g., amplifier 102 of FIG. 1, and optionally via one or more devices mounted to the PCB, as illustrated, for example, in FIG. 3B). The radiating element's first end portion 28 is attached to trace 44, preferably by solder 46. Radiating element 26 is held by clamping member 32 parallel and adjacent to trace 44 for soldering, whereby solder 46 can be conveniently placed by an automated process. A portion of clamping member 32 interfaces with an edge of PCB 22 while alignment connector 36 interfaces with a top portion of the PCB. As such, radiating element 26 is held precisely adjacent and parallel to trace 44 of PCB 22 in a reproducible manner.

In some preferred embodiments, the radiating element's first end portion 28 is disposed parallel to PCB 22, which allows for superior contact between the radiating element's first end portion 28 and trace 44. For visibility of the connection of RF radiating element 26 to trace 44, only the lower portion of clamping member 32 is shown. Clamping member 32 typically includes an electrically insulating central portion 50 surrounding RF radiating element 26 to avoid short-circuiting with the clamping member. Central portion 50 is designed, together with radiating element 26 and other features of the power module to provide a predetermined impedance value, e.g., 50 ohm or 75 ohm.

The parallel arrangement of radiating element 26 with PCB 22, facilitated by fixing of the radiating element adjacent to trace 44 by clamping member 32, allows the power module to be assembled efficiently and cost effectively. Specifically, the assembly is thus easy to assemble wherein radiating element 26 can be soldered using a robotic automated mass production method, such as surface mount technology (SMT) which reduces labor costs, reduces human error and improves quality control and uniformity (repeatability). SMT also allows automatic and reproducible control of the amount of solder, thus facilitating quality assurance of the entire RF power module. The design of attachment clamping member 32 facilitates the use of a robotic soldering step to thereby (a) prevent the use of excess solder, which can cause RF transmission issues; (b) save assembly time; and (c) improve repeatability (quality assurance) resulting in more in-tolerance product and reduce waste.

FIG. 3B is a schematic representation of a power module as described herein, supplying RF power to a cavity 106 via waveguide 52. Cavity 106 is shown holding therein an objected to be processed 120. The processing may include, for example, heating, drying, and/or cooking. The RF power module is shown to include a PCB 22 with a radiating element 26B attached to the PCB in parallel. Trace 44, to which radiating element 26 is electrically coupled, e.g., by soldering, extends from amplifier 102 to the radiating element via a circulator 104 and a coupler 108. The coupler may be used to allow a power meter 110 to measure RF power reflected back from cavity 106. Most of the reflected power is absorbed in load 114, to which it is directed via circulator 104. Also shown in FIG. 3B is a processor 112 mounted on PCB 22, receiving input from power meter 110, and controls, optionally in accordance with the input received from the power meter, the operation of the signal source 100 and of the amplifier 102. The signal source may be controlled to output signals of a given frequency, e.g., while sweeping over a predetermined frequency range. The amplifier may be controlled to amplify each signal by a respective gain.

The RF signals generated by source 100 and amplified by amplifier 102 reach radiating element 26B via trace 44, and excite RF waves in waveguide 52. The waveguide guides the waves to cavity 106 via antenna 114, which in the drawn embodiment is an aperture antenna.

FIG. 3C is a schematic representation of a power module as described in FIG. 3B, supplying RF power directly to cavity 106 (with no waveguide). The PCB 22 may be designed exactly as the PCB 22 of FIG. 3B, and matched to the cavity directly (in FIG. 3C) or via a waveguide (in FIG. 3B) by selecting different radiating elements 26C, which may differ from radiating element 26B in shape and/or size.

FIG. 3D is a schematic representation of two power modules, each supplying RF power to cavity 106 via a respective waveguide 52D1 and 52D2. The two PCBs may be designed to be functionally equivalent. Each power module may be matched to the cavity by selecting a radiating element with appropriate shape and/or size, so as to minimize difference between power transfer efficiency into the cavity from the two power modules. Details of PCBs 22 are omitted for simplicity.

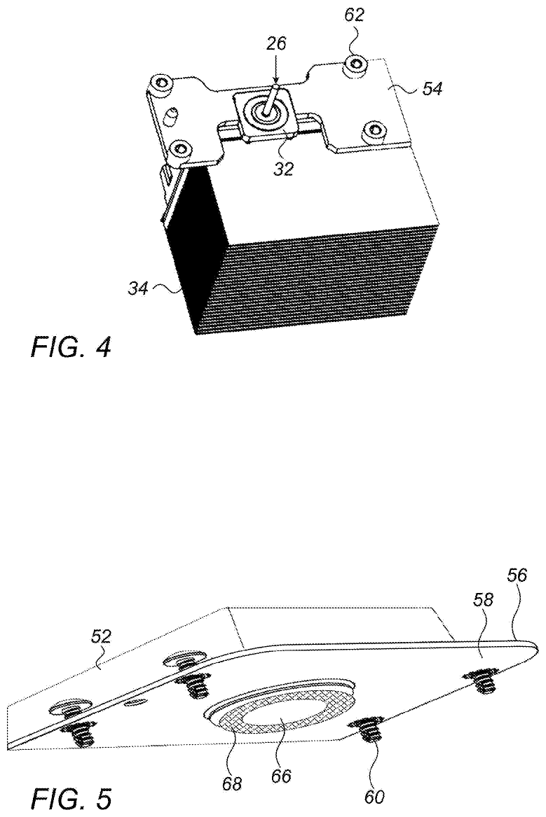

FIG. 4 shows an embodiment of the power module disclosed herein, that further includes a bracket 54, configured to connect to the waveguide of the power module via a waveguide flange 56 of a waveguide attachment plate 58 (both shown in FIG. 5) using corresponding and aligned fastening members 62 of the flange, configured to receive therein fasteners 60, such as screws, bolts, or the like.

FIG. 5 shows waveguide 52 with an attachment plate 58, configured to connect between the waveguide and bracket 54 (shown in FIG. 4). In addition to fasteners 60, mentioned above, waveguide attachment plate 58 of waveguide 52 have a radiating element receiving opening 66 through which radiating element 26, in particular second end portion 30 thereof, extends into the waveguide. An RF gasket 68 is provided to prevent RF radiation from escaping between the PCB and the waveguide (or cavity).

As such, an RF power module is provided where there are no connectors, sockets, or the like (not between the radiating element and the PCB, and not between the radiating element and the waveguide). Further, the radiating element-to-PCB connection is arranged with a parallel positioning of the radiating element to the PCB, which provides for a relatively large conductive interface there-between.

An aspect of some embodiments of the technology includes a method of attaching an RF radiating element to a PCB,

Such a method may include disposing RF radiating element 26 parallel and adjacent to trace 44 of the PCB 22; and soldering first end portion 28 of RF radiating element 26 to trace 44.

The method may further include assembling RF radiating element 26 to radiating element clamping member 32 and fastening the clamping member to PCB 22 prior to the soldering. The method may additionally include attaching PCB 22 to waveguide 52 after the soldering such that second end portion 30 of RF radiating element 26 extends into waveguide 52.

An aspect of some embodiments of the presently disclosed technology is a method of matching a given universal RF power module to a given RF consumer, which may include a cavity, and optionally also a waveguide. A power module is referred to herein as universal if it lacks the radiating element. The method includes assembling the module with a radiating element that electromagnetically matches the module to the consumer. This way, the universal RF module can serve a large variety of different RF consumers (e.g., one of the kind illustrated in FIGS. 3A, and another as illustrated in FIG. 3B), and re-designing parts of the RF power module other than the radiating element (for example, the PCB) may be omitted. Optionally, the method includes designing the radiating element for matching a given consumer to a universal RF power module. In some embodiments, a radiating element is selected by trial and error to optimize the match between the consumer and the universal RF power module.

Various exemplars of the same universal RF power module may be used in a series of various ovens, each comprising an exemplar of the universal power module, and having a different RF consumer. Similarly, two or more exemplars of a given universal RF module may be installed in a single RF cavity that is fed by respective two or more feeds, as illustrated, for example, in FIG. 3D. Each feed may be fed by a different exemplar of the same power module, and if matching differ, so that one feed is less efficient in transferring RF power to the cavity than the other, the radiating elements may be replaced with radiating elements of other shapes or sizes, until a satisfactory match is obtained with all the power modules. Exemplars of a same universal RF power module, equipped with well matching radiating elements may differ from each other by no more than 3% in the power they transmit to a 50 ohm load.

Whether the concept of universal power module is used for different ovens or for different feeds of the same oven, computer simulations may be used to determine what dimensions and/or shapes of the radiating elements would bring about acceptable or optimal results.

Thus, an aspect of some embodiments of the presently disclosed technology is an RF oven comprising two RF power modules. In some embodiments, the RF power modules are each structured as described above. In some embodiments, one or more of the RF modules is structured similarly to the defined above, but with the radiating element connected to the PCB in a different way, for example, using a connector, or as described in any one of the references mentioned in the Background section of this document.

The oven may also include a processor, configured to control and coordinate the operation of the two RF power modules, for example, to control the two RF modules to emit simultaneously radiation of the same frequency and optionally also at a desired phase difference. In some embodiments, the processor may determine the frequency and/or the desired phase difference, according to a pre-programmed heating table, according to feedback received from the cavity. Some non-limiting examples of controlling frequency, phase difference, or other field affecting parameters in response to feedback are provided in Applicants' former patent applications published as WO2011/058537 and US20130200066.

In some embodiments, the RF modules may feed the cavity directly. For example, an end of each of the radiating elements may protrude into the cavity. In such embodiments, the PCBs should be located at the vicinity of the cavity. In some embodiments, the RF modules feed the cavity via waveguides. For example, each RF module may excite electromagnetic waves in a respective waveguide, and these waves are guided by the waveguides into the cavity, for example, to heat the object.

In some embodiments, to maximize RF power transfer from the RF power module to the cavity, the two power modules should be matched to the cavity. This matching may require the two power modules to be arranged each in a different way, for example, if the two waveguides don't enter the cavity at exactly equivalent (e.g., symmetrical) positions. In some embodiments, the matching is achieved using two functionally identical PCBs (e.g., with exactly the same design), and the main difference (or, in some embodiments, the only difference) between the two power modules is the structure of the radiating element.

In some embodiments, the RF power modules are considered to be functionally identical if they transmit, to a 50 ohm load, power levels that differ from each other by 3% or less.

In some embodiments, the RF power modules are considered to be functionally identical if exchanging between the two power modules, without changing the RF cavity, waveguides, or radiating structures, does not significantly change the efficiency of RF power transfer from the RF power modules to the cavity. For example, when a given test load (e.g., a cylindrical flask filled with 1 liter of water) is in the cavity, and the magnitude of the scattering parameter S₁₁ of the two modules differ by no more than 10%. In one example, if the magnitude of S₁₁ of the first module is −20 dB, the magnitude of the S₁₁ of the second module may have any value between −18 dB and −22 dB.

In some embodiments, the radiating elements may differ from each other in shape and/or size. Preferably, the radiating elements differ from each other in length, by at least half a millimeter. In some embodiments, the radiating element has two portions: one inside the waveguide or cavity, and the other outside of it, for example, attached to the PCB. In some embodiments, the radiating element portions inside the waveguide (or inside the cavity) differ from each other, while the portions outside the waveguide are the same in all power modules. This allows the connections between the radiating elements and the PCB being the same in all the power modules, while allowing enough degrees of freedom to ensure optimal matching.

Using different radiating elements with different exemplars of the same PCB may allow for an efficient design of the oven as a whole, because a single PCB design may be used for a variety of power modules that are well matched to various cavities (or to a single cavity at different locations).

An aspect of some embodiments of the presently disclosed technology includes two RF ovens, each comprising an RF power module as described above. In some embodiments, the RF power modules are structured as described above, but with the radiating element connected to the PCB in a different way, for example, using a connector, or as described in any one of the references mentioned in the Background section of this document.

In some embodiments, the RF power modules of the two ovens are substantially identical, in the sense that replacing the power module of a first one of the two RF ovens with the power module of a second one of the two RF ovens, without changing the RF consumer and without changing the radiating structure of the first RF oven, does not significantly change the efficiency of the RF oven. For example, the magnitude of the first oven's scattering parameter S₁₁ (measured in dB) may not change by less than 10%, preferably, by less than 3%.

Each oven may further include an RF consumer configured to process an object with RF power. In some embodiments, the RF consumer includes a cavity (resonator or Faraday), configured to receive an object to be processed by RF power, and receive RF power originating from the RF power module, optionally, via a waveguide.

In some embodiments, the radiating element of each RF power module is arranged in a radiating structure configured to match the output impedance of the respective RF power module to input impedance of the respective RF consumer. For example, the radiating structure may include a radiating element shaped and/or sized to maximize matching between the RF power module, and particularly the PCB, to the RF consumer.

In some embodiments, the RF consumers differ from one another in input impedance by at least 10%.

In some embodiments, in each oven of the two RF ovens, the radiating element has a first end attached to the respective RF power module and a second end inside the respective RF consumer. Preferably, the first end is the same in the two RF ovens, and the second ends differ between the two RF ovens, for example, by shape, length, and/or width. Thus, in some examples, the second ends differ from one another in length by 0.5 a millimeter or more, e.g., by 0.5 mm, 1 mm, 1.5 mm, 2 mm, 3 mm, 5 mm, etc. Usually, the difference in length is not more than 5 mm. In some embodiments, the second ends of the radiating elements may differ by 5% or more, for example by 5%, 10%, 15% or 20%.

In some embodiments, the two radiating elements differ by shape. For example, one radiating element may be cylindrical and the other conical, a tapered cylinder, etc.

It should be understood that the above description is merely exemplary and various embodiments of the present invention may be devised, mutatis mutandis, and that the features described in the above-described embodiments, and those not described herein, may be used separately or in any suitable combination; and the invention can be devised in accordance with embodiments not necessarily described above.

1. A radiofrequency (RF) power module comprising:
a printed circuit board (PCB) having a trace; and
a radiating element having a first end portion and a second end portion, the first end portion in electrical communication with the trace of the of PCB, and the second end portion in operable communication with a microwave cavity, wherein the cavity is configured to hold an object to be heated, and
wherein the radiating element is disposed and soldered in parallel to the trace.

2. (canceled)

3. The module of claim 1, further comprising a clamping member configured to clamp a waveguide to the PCB so that the radiating element is in contact with the trace.

4. The module of claim 1, further comprising a waveguide wherein the second end of the radiating element is disposed within the waveguide.

5. The module of claim 4, wherein the second end portion of the radiating element is disposed within the waveguide without any connection fitting.

6. The module of claim 4, wherein the waveguide is connected to the PCB via a connection between an attachment plate and a bracket.

7. The module of claim 4, further comprising an RF sealing arrangement configured to prevent RF leakage from between the waveguide and the PCB.

8. A radiofrequency (RF) oven comprising:
two RF power modules, each comprising a printed circuit board (PCB) having a trace; and a radiating element having a first end portion and a second end portion, the first end portion in electrical communication with the trace of the of PCB, and the second end portion in operable communication with a microwave cavity, wherein the radiating element is disposed and soldered in parallel to the trace;
a cavity, configured to process an object with RF power originating in the two RF power modules; and
two waveguides, each configured to guide waves from a respective one of the RF power modules to the cavity.

9. The RF oven of claim 8, wherein the cavity is a resonator cavity.

10. (canceled)

11. The RF oven of claim 8, wherein each of the radiating elements has a first end attached to the respective RF power module and a second end inside the respective waveguide, and wherein the first end is the same in the two RF power modules, and the second ends differ between the two RF power modules.

12. The RF oven of claim 11, wherein the second ends differ in length by at least 0.5 mm.

13. The RF oven of claim 11, wherein the second ends differ in width by at least 10%.

14. The RF oven of claim 11, wherein the second ends differ in shape.

15. The RF oven of claim 8, wherein exchanging between the two power modules, without changing the RF cavity, waveguides, or radiating structures, does not change the efficiency of RF power transfer from the RF power modules to the cavity by more than 1%.

16.-51. (canceled)
